(19) United States
(12) Patent Application Publication
(10) Pub. No.: US 2009/0306990 A1
(43) Pub. Date: Dec. 10, 2009

(54) VOICE ACTUATED AND OPERATOR VOICE PROMPTED COORDINATE MEASURING SYSTEM

(76) Inventors: Doug Vandervoort, Novi, MI (US); Mike Brodie, Canton, MI (US); Arthur Elly, III, Brownstown, MI (US); Grant Compton, Livonia, MI (US); Hugh Brooks, Livonia, MI (US); Daniel P. Johnson, Dearborn Heights, MI (US)

Correspondence Address: PRICE, HENEVELD, COOPER, DEWITT & LITTON, LLP;FGTL, 695 KENMOOR S.E., P. O. BOX 2567, GRAND RAPIDS, MI, 49501-2567, US

(21) Appl. No.: 12/132,679

(22) Filed: Jun. 4, 2008

(51) Int. Cl. G10L 11/00

(52) U.S. Cl. 704/275

(57) ABSTRACT

A vehicle coordinate measuring system and method including a coordinate measuring device operably connected to a computer, and a voice input device for receiving prompts from the computer and enabling an operator to transmit responses to the prompts to the computer, with the computer adapted to translate the responses to digital information. The coordinate measuring device may record and transmit point location data to the computer, and the computer may correlate the point location data from the coordinate measuring device with the digital information from the responses.

### BACKGROUND OF INVENTION

a. Field of Invention

The invention relates generally to vehicle coordinate measurement, and, more particularly, to a three dimensional vehicle coordinate measuring machine adapted to provide interactive audio prompts, and receive and interpret audio directions from an operator.

b. Description of Related Art

As is known in the art, a three dimensional coordinate measuring machine may be utilized to measure the three dimensional surfaces of components, systems and vehicles. Methods such as touch point scanning and laser scanning, as well as others, are presently used depending on the surface of an object for coordinate measurement. Three dimensional coordinate measuring systems generally include a system for gathering and assembling a number of points from an input device and mapping these points using a computer aided design software.

One such three dimensional coordinate measuring system is disclosed in U.S. Pat. No. 5,590,060 to Granville in which FIGS. 1 and 2 show object measurement system (100) including an audio feedback device (9) which may be used in conjunction with interactive user interface device (7) provided for object measurement. While the Granville measurement system is adequate for measurement of certain small objects which may fit in the inspection area of system (100), it is nevertheless unsuitable for measurement of large objects such as cars and the like.

For automobiles in particular, three dimensional coordinate measuring systems exist for sampling a large number of points from both the interior and exterior space of an automobile. In such systems, as briefly discussed above, the points may be mapped by computer aided design software. Points may be measured relative to a known reference by means of a multi-axis articulating arm measuring device. Upon alignment of the device tip with the point which is desired to be measured, the position of the point with respect to an origin is calculated and stored. The software may be adapted with pre-programmed information to enable it to predict and interpret the point inputs received from the coordinate measuring device by reference to pre-programmed dimensional information. Since an article of which one desires to take coordinate measurements will often have a preferred sequence of taking measurements, the type of article, such as an automobile, may be input by the operator. For example, a pickup truck may require dimensions to be taken inside the cab, inside the pick-up box, and on the outside surface of the vehicle. These established measurement steps could be pre-programmed into the data acquisition computer program. The program would calculate which points and surfaces to prompt the operator to measure based on the type of vehicle or system according to a pre-programmed sequence.

For existing systems, the task of gathering such data is very time consuming due to the considerable number of points and surfaces required. Typically, the operator must reach into various remote locations within the vehicle to align the coordinate measuring device with the point to be input. After every such input, the operator must return to a computer or other such base station to receive computer prompts and input further information to the computer or base station. The laborious process of traveling between the measured point and the base station is undesirable, and significantly increases the time required to complete the task.

Moreover, physical scanning of the desired article is generally followed by post processing of data to identify what component or feature of a vehicle that each series of points and surfaces represent. Scanning of an entire vehicle for occupant accommodation and ergonomics purposes may require over fifty man-hours.

Accordingly, there remains a need for a vehicle coordinate measuring machine, which facilitates the coordinate measuring process, and reduces the man-hours required for scanning of a typical vehicle. There also remains a need for a vehicle coordinate measuring machine which is economical to manufacture, install and service, and which is further robust in design for long term use for a variety of vehicles.

### SUMMARY OF INVENTION

The invention solves the problems and overcomes the drawbacks and deficiencies of prior art vehicle coordinate measuring machines by providing a vehicle coordinate measuring system including a coordinate measuring device operably connected to a computer, and a voice input device for receiving prompts from the computer and enabling an operator to transmit responses to the prompts to the computer, with the computer adapted to translate the responses to digital information. The coordinate measuring device may record and transmit point location data to the computer, and the computer may correlate the point location data from the coordinate measuring device with the digital information from the responses.

For the vehicle coordinate measuring system described above, the system may further include a voice output device which receives instructions from a pre-programmed scanning routine, translates the instructions into vocal commands or queries, and transmits the voice commands or queries from a speaker. In particular embodiments, the voice input and output devices may wirelessly transmit to/from the computer, the voice input and output devices may wirelessly transmit to/from the coordinate measuring device, and/or the coordinate measuring device may wirelessly transmit to/from the computer. The voice input device may be a headset including a microphone and a radio frequency receiver/transmitter, with the computer having a radio frequency receiver/transmitter. The voice input device may be a microphone connected to the computer. The coordinate measuring device may be a multi-axis measuring arm with a touchpoint tip for measuring tip location, or alternatively, the coordinate measuring device may be a laser scanner.

The invention also provides a method of measuring coordinates. The method may include programming a computer with coordinate measuring routines for known objects, providing a coordinate measuring system including a coordinate measuring device, voice input and output devices, and a computer, and querying an operator, through voice queries generated by the programmed computer, for a type of object. The method may further include selecting a matching object from known objects, querying the operator, through voice queries generated by the programmed computer, to measure at least one feature of the object, and measuring the at least one feature. The method may also include providing a voice command to the computer stating completion of the at least one feature measurement, providing a voice command to the computer stating completion of the object measurement, and storing measurement information by correlating measurement data from the coordinate measuring device with digital information from the voice command upon completion of the at least one feature measurement.

The invention yet further provides a method of measuring coordinates. The method may include providing a coordinate measuring system including a coordinate measuring device, voice input and output devices, and a computer, querying an operator, through voice queries generated by the computer, for a type of an object to be measured, and querying the operator, through voice queries generated by the computer, to measure at least one feature of the object. The method may also include measuring the at least one feature, providing a voice command to the computer stating completion of the at least one feature measurement, providing a voice command to the computer stating completion of the object measurement, and storing measurement information by correlating measurement data from the coordinate measuring device with digital information from the voice command upon completion of the at least one feature measurement.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a diagram illustrative of an embodiment of a vehicle coordinate measuring machine according to the present invention;

FIG. 2 is a diagram illustrative of an alternative embodiment of the vehicle coordinate measuring machine of FIG. 1; and

FIG. 3 is a flow-chart illustrative of a vehicle coordinate measuring method according to the present invention.

### DETAILED DESCRIPTION OF THE PREFERRED EMBODIMENTS

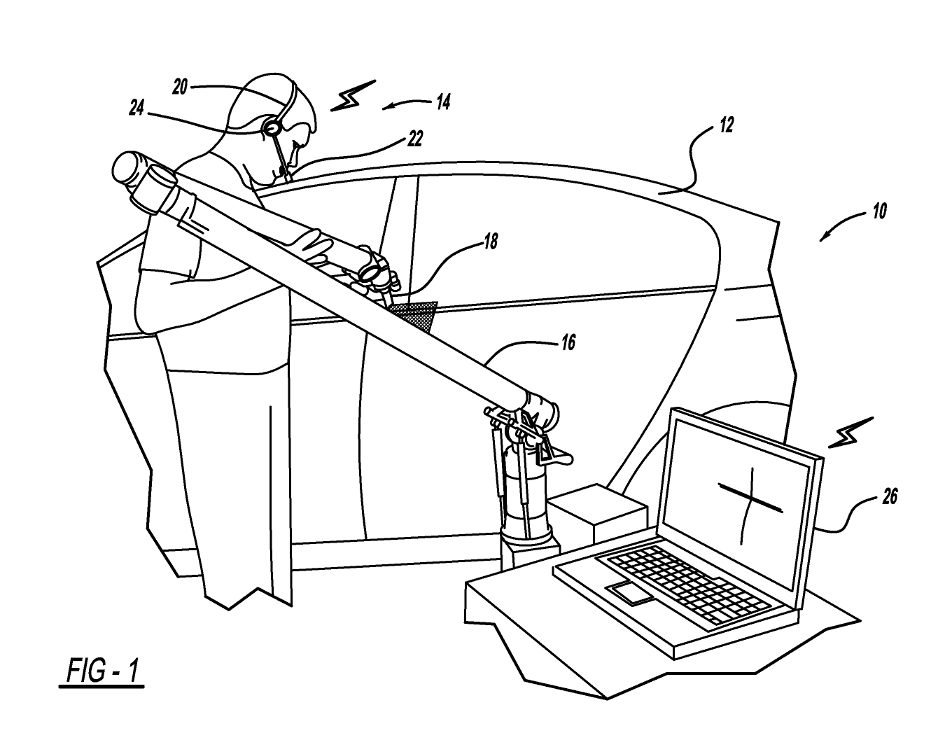

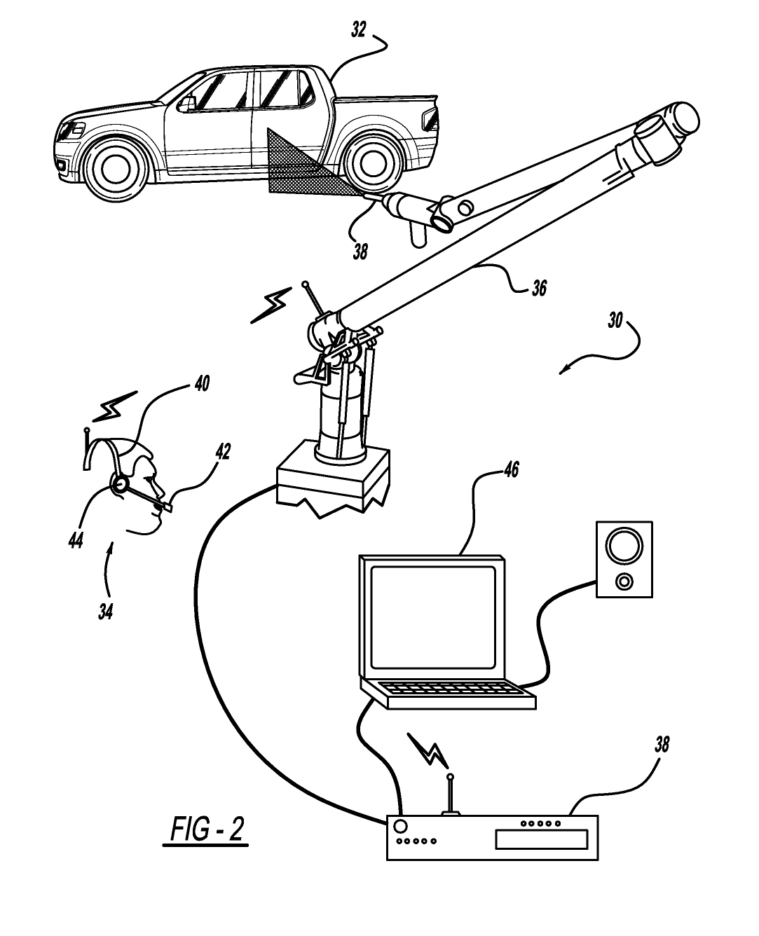

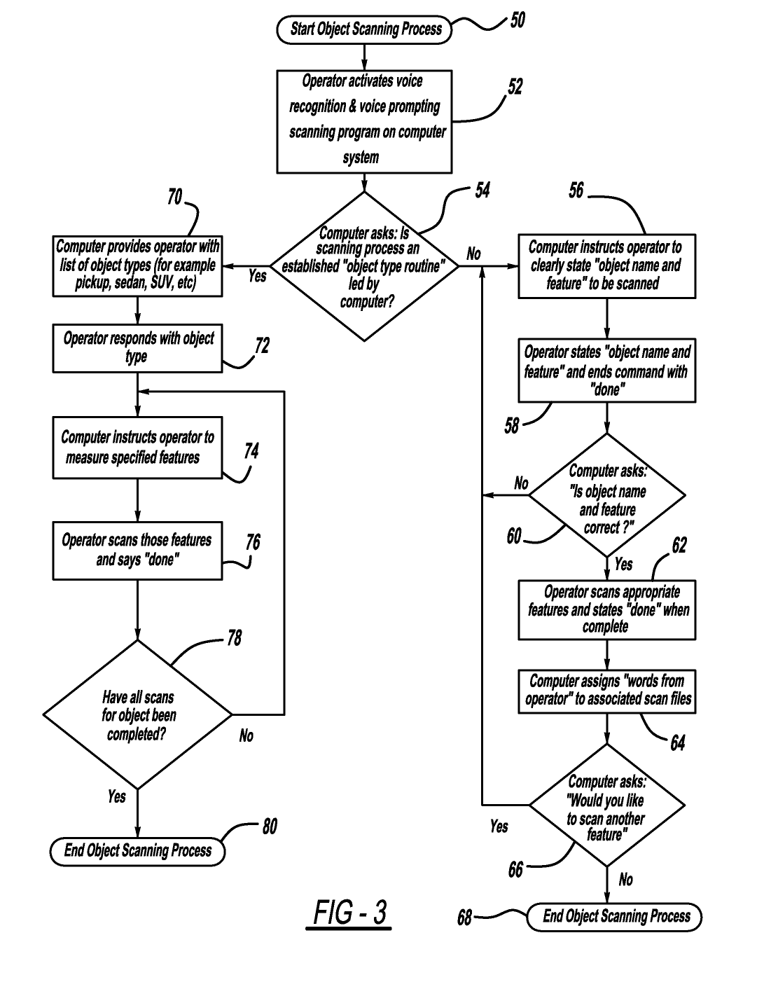

Referring now to the drawings wherein like reference numerals designate corresponding parts throughout the several views, FIGS. 1 and 2 illustrate representations of the components of a vehicle coordinate measuring machine according to the present invention, generally designated “vehicle coordinate measuring system 10,” and FIG. 3 is a flow-chart illustrative of a vehicle coordinate measuring method according to the present invention.

Referring now to FIG. 1, several components of vehicle coordinate measuring system 10 are depicted. In order to measure the coordinates of a vehicle 12, an operator 14 may manipulate a multi-axis coordinate measuring arm 16, which is provided with a reference point tip 18. Arm 16 may be manipulated to various positions in contact with vehicle 12, or another article as readily apparent to those skilled in the art. System 10 may include a headset 20 including a microphone 22 and at least one speaker or earphone 24. Headset 20 and a computer 26 may be in wired or wireless communication. A coordinate measurement program executed on computer 26 may prompt the operator with verbal commands and queries, which may then be passed electronically between the operator and computer, as discussed in greater detail below with reference to FIG. 3. Further computer 26 and measuring arm 16 may also be in wired or wireless communication to allow coordinate point information to be passed from measuring arm 16 to computer 26.

Referring to FIG. 2, an alternative embodiment of vehicle coordinate measuring system 30 is depicted. In order to measure the coordinates of a vehicle 32 using system 30, operator 34 may wirelessly manipulate powered multi-axis coordinate measuring arm 36, which is provided with a reference point tip 38. Arm 36 may be wirelessly manipulated to various positions in contact with vehicle 32, or another article as readily apparent to those skilled in the art. System 30 may include a headset 40 including a microphone 42 and at least one speaker or earphone 44 for wireless communication with arm 36 and an intermediate station 38. Intermediate station 38 may be utilized to pass electronic information wirelessly between a computer 46 and headset 40, and also to pass information via wire or wirelessly between computer 46 and measuring arm 36. Headset 40 and computer 46 may be wired or wireless. Similar to the FIG. 1 embodiment, a coordinate measurement program executed on computer 46 may prompt the operator with verbal commands and queries (discussed in detail below), which may then be passed electronically between the operator and computer.

Referring next to FIG. 3, a flowchart illustrative of a vehicle coordinate measuring method according to the present invention will now be described in detail.

Specifically, referring to FIG. 3, an object scanning process 50 may begin with an operator activating a voice recognition and voice prompting program on computer 26 (or 46) at step 52. At step 54, the computer of system 10 (or 30) may verbally query the operator whether the article to be measured, or scanned, is a pre-programmed “object type routine” guided by the computer programming. If the response from the operator is NO, at step 56, the computer may instruct the operator to verbally state the object name and feature to be scanned. At step 58, the operator may verbally state the object name and feature and verbally indicate completion. At step 60, the computer may verbally recite the operator's stated object name, which may include interpreting the operator's verbal input into digital textual form, and translating the textual form to computer generated speech. If the operator indicates the computer's recited name is incorrect, steps 56, 58 and 60 may be repeated. If the operator indicates the computer's recited name is correct, the operator may thereafter commence, at step 62, with collection of coordinate measurement points of the object and verbally state when complete. At step 64, the computer may then assign the operator's verbal commands and statements to associated scan files containing the measured points. At step 66, the operator may optionally instruct the computer to perform further object scans to return to step 56, or complete the scanning process at step 68.

If the operator's verbal response to the computer's verbal query at step 54 as to whether the object scanning is an “object type routine” is affirmative, the system may proceed to step 70. At step 70, the computer may provide the operator with a list of object types (e.g., pickup, sedan, SUV, etc.). At step 72, the operator may state the type of object to be scanned/coordinate measured. Upon confirmation of the desired object, at step 74, the computer may proceed to verbally instruct the operator to collect data points from verbally specified features. At step 76, the operator may indicate when the measuring of the stated features is complete. At step 78, the operator may optionally instruct the computer whether scanning of the object is complete, with a negative response causing steps 74, 76 and 78 to be repeated, and with an affirmative response completing the scanning process at step 80.

To summarize, vehicle coordinate measuring system 10 thus facilitates the coordinate measuring process, and reduces the man-hours required for scanning of a typical vehicle by eliminating the requirement for an operator to, for example, reach into various remote locations within a vehicle to align the coordinate measuring device with the point to be input, and after every such input, return to a computer or other such base station to receive computer prompts and input further information to the computer or base station. System 10 thus also eliminates certain post processing steps of identifying what component or feature of a vehicle that each series of points and surfaces represent, since such steps are prompted during the scanning process.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A vehicle coordinate measuring system comprising:
a coordinate measuring device operably connected to a computer; and
a voice input device for receiving prompts from said computer and enabling an operator to transmit responses to said prompts to said computer, said computer adapted to translate said responses to digital information,
wherein said coordinate measuring device records and transmits point location data to said computer, and said computer correlates said point location data from said coordinate measuring device with said digital information from said responses.

2. A vehicle coordinate measuring system according to claim 1, further comprising a voice output device which receives instructions from a pre-programmed scanning routine, translates said instructions into vocal commands or queries, and transmits said voice commands or queries from a speaker.

3. A vehicle coordinate measuring system according to claim 2, wherein said voice input and output devices wirelessly transmit to/from said computer.

4. A vehicle coordinate measuring system according to claim 2, wherein said voice input and output devices wirelessly transmit to/from said coordinate measuring device.

5. A vehicle coordinate measuring system according to claim 1, wherein said coordinate measuring device wirelessly transmits to/from said computer.

6. A vehicle coordinate measuring system according to claim 1, wherein said voice input device is a headset including a microphone and a radio frequency receiver/transmitter, said computer having a radio frequency receiver/transmitter.

7. A vehicle coordinate measuring system according to claim 1, wherein said voice input device is a microphone connected to said computer.

8. A vehicle coordinate measuring system according to claim 1, wherein said coordinate measuring device is a multi-axis measuring arm with a touchpoint tip for measuring tip location.

9. A vehicle coordinate measuring system according to claim 1, wherein said coordinate measuring device is a laser scanner.

10. A method of measuring coordinates, the method comprising:
programming a computer with coordinate measuring routines for known objects;
providing a coordinate measuring system including a coordinate measuring device, voice input and output devices, and a computer;
querying an operator, through voice queries generated by the programmed computer, for a type of object;
selecting a matching object from known objects;
querying the operator, through voice queries generated by the programmed computer, to measure at least one feature of the object;
measuring the at least one feature;
providing a voice command to the computer stating completion of the at least one feature measurement;
providing a voice command to the computer stating completion of the object measurement; and
storing measurement information by correlating measurement data from the coordinate measuring device with digital information from the voice command upon completion of the at least one feature measurement.

11. A method according to claim 10, wherein the voice input and output devices wirelessly transmit to/from the computer.

12. A method according to claim 10, wherein the voice input and output devices wirelessly transmit to/from the coordinate measuring device.

13. A method according to claim 10, wherein the coordinate measuring device wirelessly transmits to/from the computer.

14. A method of measuring coordinates, the method comprising:
providing a coordinate measuring system including a coordinate measuring device, voice input and output devices, and a computer;
querying an operator, through voice queries generated by the computer, for a type of an object to be measured;
querying the operator, through voice queries generated by the computer, to measure at least one feature of the object;
measuring the at least one feature;
providing a voice command to the computer stating completion of the at least one feature measurement;
providing a voice command to the computer stating completion of the object measurement; and
storing measurement information by correlating measurement data from the coordinate measuring device with digital information from the voice command upon completion of the at least one feature measurement.

15. A method according to claim 14, wherein the voice input and output devices wirelessly transmit to/from the computer.

16. A method according to claim 14, wherein the voice input and output devices wirelessly transmit to/from the coordinate measuring device.

17. A method according to claim 14, wherein the coordinate measuring device wirelessly transmits to/from the computer.
